(19) United States
(12) Patent Application Publication
(10) Pub. No.: US 2026/0076848 A1
(43) Pub. Date: Mar. 19, 2026

(54) BED WITH ADAPTIVE PORTIONS

(71) Applicant: Slept Technologies Research and Development India Private Limited, Hyderabad (IN)

(72) Inventor: Kalyana Raghava Teja Vinukollu, Hyderabad (IN)

(21) Appl. No.: 19/328,095

(22) Filed: Sep. 12, 2025

(30) Foreign Application Priority Data
Sep. 13, 2024 (IN) 202441069215

(51) Int. Cl. A61G 7/015; A61G 7/05; A61G 7/057; A61G 7/10

(52) U.S. Cl. CPC A61G 7/015; A61G 7/0525; A61G 7/05715; A61G 7/1019; A61G 2200/32

(57) ABSTRACT

A bed (102) with adaptive portion (108) is disclosed. The bed (102) includes a surface grid (106). The surface grid (106) includes at least one adaptive portion (108), at least one actuator (210) coupled to the at least one adaptive portion (108), a controller (608), and a memory (610) communicably coupled to the controller (608). The memory (610) may include a set of instructions which when executed by the controller (608), causes the controller (608) to determine a flawed posture corresponding to a user (902). The controller (608) generates an actuation signal comprising information associated with a corrected posture corresponding to the flawed posture to at least one actuator (210). Further, controller (608) adapts the at least one actuator (210) based on the actuation signal for adapting the at least one adaptive portion (108) in accordance with the corrected posture for correcting the flawed posture of the user (902).

### TECHNICAL FIELD

This disclosure relates generally to adaptive surfaces, and more particularly to a furniture such as a bed with adaptive surfaces.

### BACKGROUND

Beds and mattresses are engineered to furnish users with comfort during periods of sleep, sitting, or intimate activities. For instance, users exhibit diverse physiological and physical characteristics and may exhibit varied responses during sleep. During sleep, certain users may adopt a flawed posture attributable to inadequate bed design, insufficient mattress firmness, inadequate pillow thickness, and similar factors. For example, the individuals with a greater height slouch to align with lower desks, counters, or to speak with shorter people, leading to rounded shoulders and forward head posture. Further, the individual with long arms or legs may create awkward joint angles if the person sits in a standard bed, chair or uses standard equipment. Therefore, the long legs may cause the knees to sit higher than hips, tilting the pelvis backward and leading to a slouched spine.

Such flawed posture induces excessive and undesirable stress and tension on multiple joints of the body, as well as the neck of the user. This flawed posture may be subconsciously assumed by the user during sleep. Moreover, persistently sleeping in such a flawed posture may induce discomfort during sleep and contribute to long-term health issues, including suboptimal spinal alignment, joint pain, and cervical spondylosis, among others.

Therefore, the bed and mattress encompass limitations in design features. Due to such limitations, the posture of the user may be adversely affected when engaged in activities such as relaxation, sleeping, intimacy, and leisure pursuits, including reading, meditation, and watching movies, among others.

Therefore, the present invention is directed towards overcoming one or more limitations stated above or any other limitations associated with the known arts.

### SUMMARY

In one embodiment, a method of adapting a bed is disclosed. The method may include determining, by a controller, a flawed posture corresponding to a user, based on one or more attributes of the user when the user is in contact with at least one adaptive portion within a surface grid of the bed. The method may include generating, by the controller, an actuation signal comprising information associated with a corrected posture corresponding to the flawed posture to at least one actuator. The at least one actuator is coupled to at least one adaptive portion in contact with the user. Further, the method may include adapting, by the controller, the at least one actuator based on the actuation signal for adapting the at least one adaptive portion in accordance with the corrected posture for correcting the flawed posture of the user.

In another embodiment, a bed is disclosed. The bed may include a surface grid. The surface grid may include at least one adaptive portion, at least one actuator coupled to the at least one adaptive portion, a controller, and a memory communicably coupled to the controller. The memory may include a set of instructions which when executed by the controller, may cause the controller to determine a flawed posture corresponding to a user, based on one or more attributes of the user when the user is in contact with at least one adaptive portion within a surface grid of the bed. The set of instructions may cause the controller to generate an actuation signal comprising information associated with a corrected posture corresponding to the flawed posture to at least one actuator. The at least one actuator is coupled to at least one adaptive portion in contact with the user. Further, the set of instructions may cause the controller to adapt the at least one actuator based on the actuation signal, to adapt the at least one adaptive portion in accordance with the corrected posture to correct the flawed posture of the user.

In yet another embodiment, an application server for adapting a bed is illustrated. The application server for adapting the bed may include a controller and a memory communicably coupled to the controller. The memory may include a set of instructions which when executed by the controller, may cause the controller to determine a flawed posture corresponding to a user, based on one or more attributes of the user when the user is in contact with at least one adaptive portion within a surface grid of the bed. The set of instructions may cause the controller to generate an actuation signal comprising information associated with a corrected posture corresponding to the flawed posture to at least one actuator. The at least one actuator is coupled to at least one adaptive portion in contact with the user. The set of instructions may cause the controller to adapt the at least one actuator based on the actuation signal, the at least one adaptive portion in accordance with the corrected posture to correct the flawed posture of the user.

In yet another embodiment, a furniture is disclosed. The furniture may include a surface grid. The surface grid may include at least one adaptive portion, at least one actuator coupled to the at least one adaptive portion, a controller, and a memory communicably coupled to the controller. The memory may include a set of instructions which when executed by the controller, may cause the controller to determine a flawed posture corresponding to a user, based on one or more attributes of the user when the user is in contact with at least one adaptive portion within a surface grid of the furniture. The set of instructions may cause the controller to generate an actuation signal comprising information associated with a corrected posture corresponding to the flawed posture to at least one actuator. The at least one actuator is coupled to at least one adaptive portion in contact with the user. Further, the set of instructions may cause the controller to adapt the at least one actuator based on the actuation signal, to adapt the at least one adaptive portion in accordance with the corrected posture to correct the flawed posture of the user.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, explain the disclosed principles.

FIG. 1 illustrates a top view of a bed, in accordance with some embodiments of the present disclosure.

FIG. 2 illustrates a side view of the bed with at least one adaptive portion, in accordance with some embodiments of the present disclosure.

FIG. 3 illustrates a sectional view of an actuator from at least one actuator, in accordance with some embodiments of the present disclosure.

FIG. 4A illustrates a perspective view of the adaptive portion from the at least one adaptive portion, in accordance with some embodiments of the present disclosure.

FIG. 4B illustrates a first-perspective view of the at least one adaptive portion coupled to the at least one actuator, in accordance with some embodiments of the present disclosure.

FIG. 4C illustrates a second-perspective view of the at least one adaptive portion coupled to the at least one actuator, in accordance with some embodiments of the present disclosure

FIG. 5 illustrates a sectional view of the bed with the at least one portion 108 in an actuated state, in accordance with some embodiments of the present disclosure.

FIG. 6 illustrates a block diagram of a bed actuation system, in accordance with some embodiments of the present disclosure.

FIG. 7 illustrates another block diagram of the bed adapting system, in accordance with some embodiments of the present disclosure.

FIG. 8 illustrates a methodology of adapting the bed, in accordance with some embodiments of the present disclosure.

FIG. 9 illustrates a first-side view of the bed, in accordance with some embodiments of the present disclosure.

FIG. 10 illustrates a second-side view of the bed in a corrected posture, in accordance with some embodiments of the present disclosure.

FIG. 11 illustrates a perspective view of the bed in a safety configuration, in accordance with some embodiments of the present disclosure.

FIG. 12 illustrates a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

As previously discussed, the design of the bed and mattress inadequately addresses comfort and the alleviation of the pressure on the multiple joints according to the plurality of physiological characteristics of the user. Moreover, the limited design features frequently results in back pain and improper spinal alignment. As a result, the provision of comfort and adjustability for users utilizing mattresses may become increasingly significant to enable engagement in relaxing and intimate activities without experiencing back discomfort.

Therefore, a bed with adaptive portions is disclosed. The bed may be configured to assist the user in relaxing activities, such as, but not limited to, sleeping, meditation, reading, and the like, and intimate activities. The bed may include a provision of enhancing the comfort of the user by providing support especially, on a plurality of contact points of a body of the user. By way of example, the plurality of contact points may include but is not limited to a plurality of body parts that may come in contact with the bed. It is to be noted, that the plurality of contact points may be exerted with a constant pressure and stress when the user may be performing relaxing and intimate activities. For example, during relaxing activities, the body of the user may be in a stationary position, and over a period of time the stational position may become a flawed posture. This stationary position may be undesirable for the physiology of the user and may result in the development of the pressure and stress on the plurality of contact points. Further, during the intimate activities, the plurality of contact points may be dynamic and may require correction in the posture based on the change in the real-time posture of the user. Therefore, the bed may be configured to support the plurality of contact points and correct the flawed posture of the user. It must be noted that the systems and methods disclosed herein may not be limited to a bed. As may be understood and appreciated by a person skilled in the art, the systems and methods disclosed herein may also be implemented on various furniture such as chairs, couches, and the like.

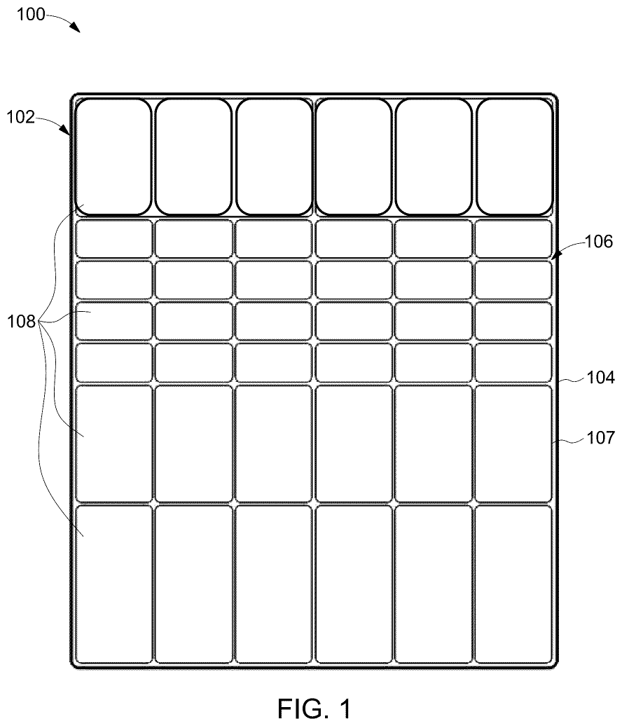

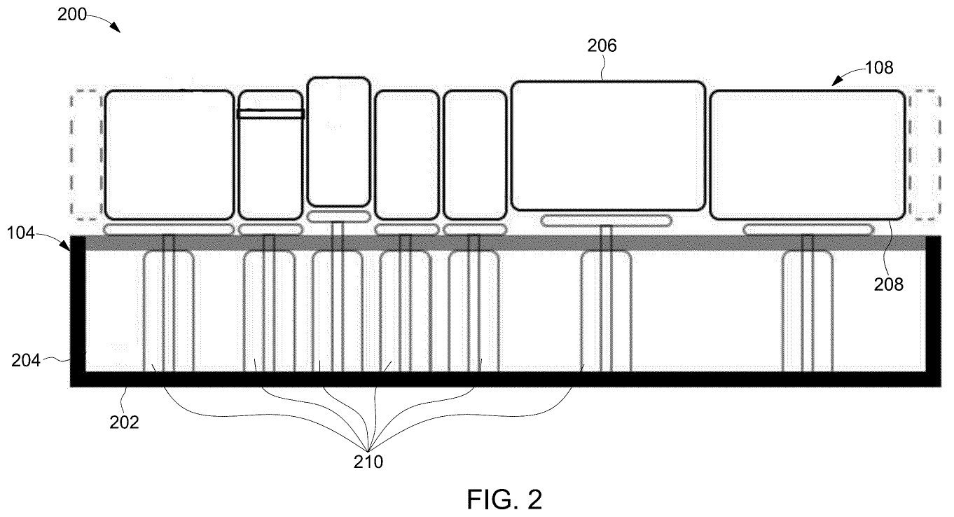

Referring to FIG. 1, a top view 100 of a bed 102 is illustrated, in accordance with an embodiment of the present disclosure. In an embodiment, the bed 102 may include a main frame 104 and a surface grid 106 disposed on the main frame 104. By way of example, the bed 102 may be configured to accommodate at least one user and allow the at least one user to relax, or perform intimate activities. The main frame 104 may be configured to support the surface grid 106. The assembly of the main frame 104 is explained in greater details in conjunction with FIG. 2.

The surface grid 106 may define a perimeter 107 and may include at least one adaptive portion 108. Each adaptive portion 108 may be communicably interconnected. Each adaptive portion 108 may be sequentially stacked to each other, such that the surface grid 106 may be formed. Each adaptive portion 108 may define a cushioning space, which may allow accommodation of at least one user. By way of example, the at least one adaptive portion 108 may be a mattress and may contact with a plurality of contact points of the user. Further, each adaptive portion 108 may be of variable dimensions based on the plurality of contact points of the body. As the name suggests, the at least one adaptive portion 108 may be adapted to correct the flawed posture of the at least one user to a correct posture. The at least one portion 108 may be microadjusted, or raised or lowered by a predefined distance and tilted by a predefined angle to achieve the correct posture. This is explained in greater details, hereinafter.

Referring to FIG. 2, a side view 200 of the bed 102 with the at least one adaptive portion 108 is illustrated, in accordance with an embodiment of the present disclosure. As explained earlier, the bed 102 with adaptive portion 108 may include the main frame 104 and the at least one adaptive portion 108 coupled to the main frame 104. The main frame 104 may include a base 202 and a plurality of panels 204 interconnected and connected to the base 202 using fastening methods commonly known in the art. The main frame 104 may be configured to accommodate the at least one adaptive portion 108. Further, the at least one adaptive portion 108 may include a top portion 206, and a bottom portion 208 disposed opposite to the top portion 206. The top portion 206 may be configured to contact with the plurality of contact points of the at least one user.

In an embodiment, the at least one adaptive portion 108 may be coupled to at least one actuator 210. Each actuator 210 may be positioned at the base 202 and adjoined to the bottom portion 208 of the corresponding adaptive portion 108. By way of example, the actuator may be coupled to the base 202 and the corresponding adaptive portion 108 by utilizing fastening methods commonly known in the art. Further, each actuator 210 may be configured to adjust the height of the at least one adaptive portion 108 to achieve the correct posture. For example, each actuator 210 may actuate the corresponding adaptive portion 108 such that, the flawed posture of the at least user may be corrected. The actuation of the at least one actuator 210 may include manipulating the actuator 210 to raise or lower the at least one adaptive portion 108 corresponding to the flawed posture by the predefined distance. Therefore, the at least one adaptive portion 108 may undergo a vertical movement. The assembly of the actuator 210 is explained in greater details, hereinafter.

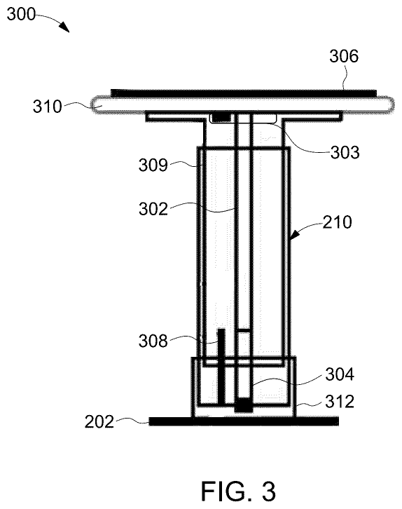

Referring to FIG. 3, a sectional view 300 of the actuator 210 from the at least one actuator 210 is illustrated, in accordance with an embodiment of the present disclosure. As explained earlier, the at least one actuator 210 may be operatively coupled to the at least one adaptive portion 108, and may be configured to raise or lower the at least one adaptive portion 108 to correct the flawed posture of the at least one user. This is explained in greater details, hereinafter.

In an embodiment, each actuator 210 may include a telescopic arm 302 coupled to the corresponding adaptive portion 108, a lifting column 303 coupled to the telescopic arm 302, a magnetic pin connector 304 coupled to the telescopic arm 302, a sensor unit 306 adjoined to the telescopic arm 302, and a control circuit 308 operatively coupled to the telescopic arm 302 and the magnetic pin connector 304, and communicably coupled to the sensor unit 306.

The telescopic arm 302 may be coupled to the bottom portion 208 of the corresponding adaptive portion 108 and pivoted to the base 202. The telescopic arm may be accommodated within a housing 309. The housing 309 may be T-shaped defining a top section 310, and a bottom section 312 disposed opposite to the top section 310. The housing 309 may be formed corresponding to the telescopic arm 302. The top section 310 may define a resting surface for the corresponding adaptive portion 108, thereby the top section 310 may be secured with the bottom portion 208. By way of another example, the resting surface may be retrofitted as the top section 310. Further, the telescopic arm 302 may be actuated by the lifting column 303 to raise or lower the at least one adaptive portion 108 corresponding to the flawed posture by the predefined distance. For example, the lifting column 303 may be configured to exert a linear force on the telescopic arm 302 to undergo the vertical movement thereof by the predefined distance. By way of example, the predefined distance may be an actuation distance of the telescopic arm 302 which may be attained in response to the operation of the telescopic arm 302.

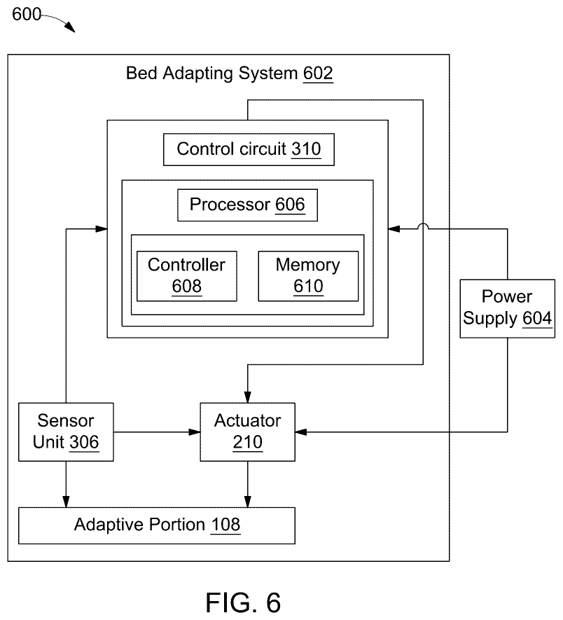

The telescopic arm 302 be actuated by the lifting column 303 accommodated between the bottom portion 208 of the at least one adaptive portion 108. By way of example, the lifting column 303 may be an electric-linear actuator, and the like. The lifting column 303 may be configured to adjust the height of the telescopic arm 302 by the predefined distance. Upon attaining the predefined distance, movement of the telescopic arm 302 may be restricted by the engagement of the magnetic pin connector 304 thereto. This is explained in greater details, in conjunction with FIG. 6.

The sensor unit 306 may be adjoined to the top section 310 and the bottom portion 208. In other words, the sensor unit 306 may be sandwiched between the top section 310 and the bottom portion 208 (refer to FIG. 2). The sensor unit 306 may be, for example, but may not be limited to, a pressure sensor, a proximity sensor, a hear rate sensor, a load sensor, a thermal imaging sensor, a Hall-effect sensor, and the like. By way of example, the heart rate sensor may be equipped with each adaptive portion 108.

The sensor unit 306 may operate in conjunction with the control circuit 308 to determine flawed posture of the user when the user may be in contact with the at least one adaptive portion 108. The flawed posture may be based on the one or more attributes of the at least one user in contact with the at least one adaptive portion 108. It is to be noted, the at least one adaptive portion 108 may be interconnected therefore, the at least one telescopic arm 302 may be simultaneously actuated to adjust according to the one or more attributes of the at least one user. Based on the flawed posture, the telescopic arm 302 may be actuated to raise or lower the at least one adaptive portion 108 by the predefined distance. Further, the determination of the flawed posture is explained in greater details in conjunction with FIG. 6. The interconnection of the at least one adaptive portion 108 is explained in greater details, hereinafter.

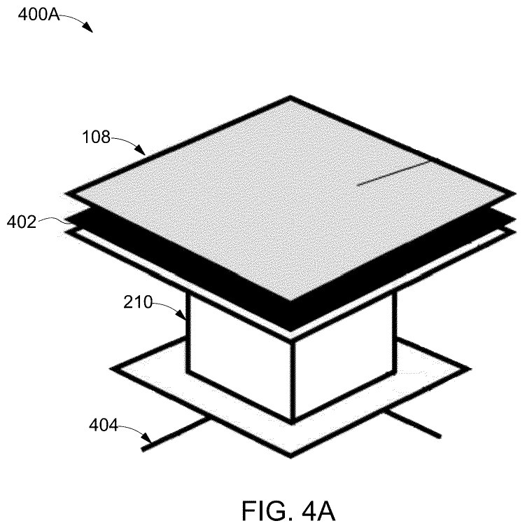

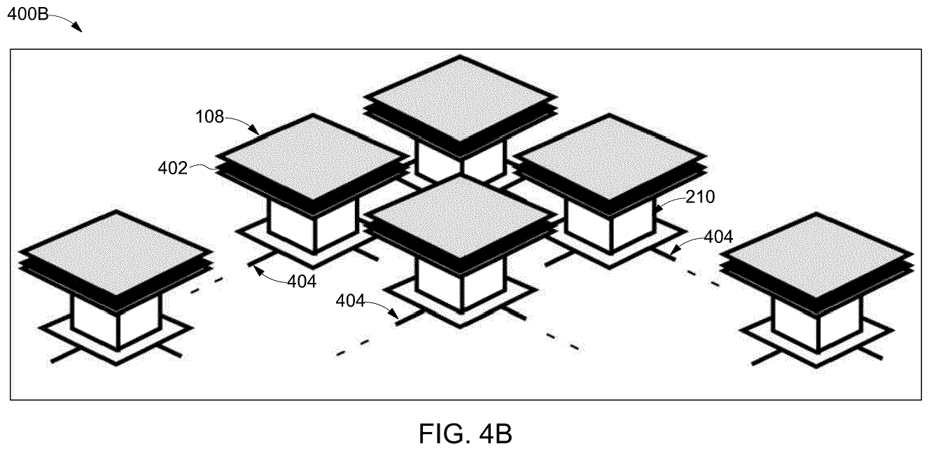

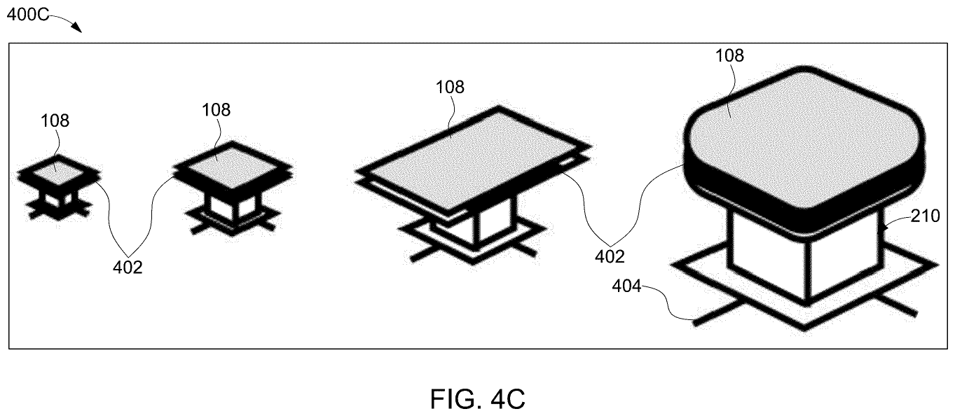

Referring to FIG. 4A, a perspective view 400A of the adaptive portion 108 from the at least one adaptive portion 108 is illustrated, in accordance with an embodiment of the present disclosure. As explained earlier, the at least one adaptive portion 108 may be coupled to the at least one actuator 210. Each adaptive portion 108 may include the top portion 206 and a pressure sensor 402 from the sensor unit 306 disposed beneath the top portion 206. The operation of the sensor unit 306 is explained in greater detail in conjunction with FIGS. 6-8.

Further, each actuator 210 may be interconnected via a communication link 404 such that the at least one adaptive portion 108 may be selectively raised or lowered to correct the flawed postures to a corrected posture. Further, the operation of the communication link 404 with the sensor unit 306, and the actuation of the actuator 210 is explained in greater details in conjunction with FIGS. 6-8.

Referring to FIG. 4B, a first-perspective view 400B of the at least one adaptive portion 108 coupled to the at least one actuator 210 is illustrated, in accordance with an embodiment of the present disclosure. FIG. 4B is explained in conjunction with FIG. 4A. FIG. 4B depicts the at least one adaptive portion 108 interconnected via the communication link 404. Further, the communication link 404 may be communicably coupled to the sensor unit 306. Such interconnection may be capable of adapting the at least one adaptive portion 108 to be raised or lower based on the flawed posture of the user.

Referring to FIG. 4C, a second-perspective view 400C of the at least one adaptive portion 108 coupled to the at least one actuator 210 is illustrated, in accordance with an embodiment of the present disclosure. Each adaptive portion 108 may be variable dimensions which may be based on physical characteristics of the body of the user of the body of the user, which may include, but not limited to height, weight, and the like. Each adaptive portion 108 may be adjoined to the main frame 104 such that the plurality of contacts points may be supported.

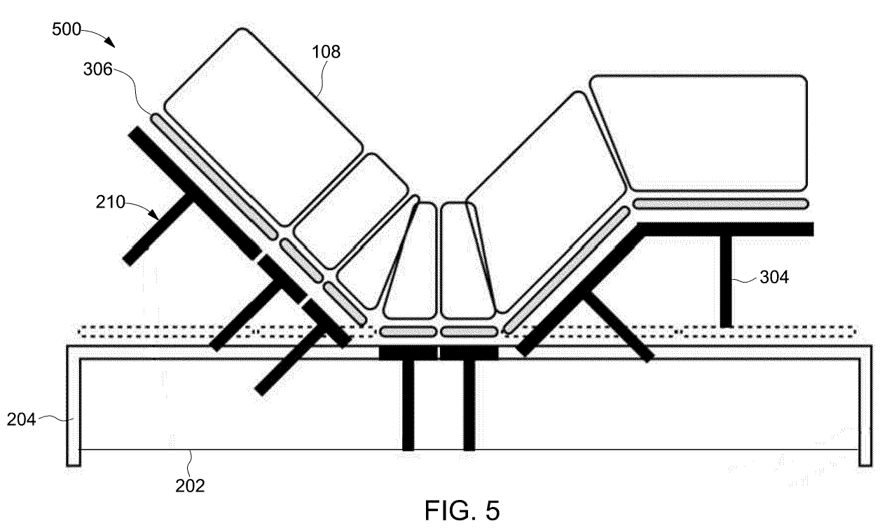

Referring to FIG. 5, a sectional view 500 of the bed 102 with at least one adaptive portion 108 in an actuated state is illustrated, in accordance with an embodiment of the present disclosure. FIG. 5 depicts the at least one adaptive portion 108 in the actuated state. In the actuated state, the at least one adaptive portion 108 may be raised or lowered based on the flawed posture of the user. Such actuation may be achieved when the actuator 210 may be operated by the control circuit 308 based on the one or more attributes of the user. Moreover, the actuator 210 may be configured to tilted by the predefined angle such that, the flawed posture may be corrected efficiently.

The flawed posture may be determined by processing the one or more attributes corresponding to the at least one user via the sensor unit 306 coupled to the control circuit 308. The tilting and the vertical movement of the telescopic arm 302 may be capable of positioning the at least one user in the correct posture from the flawed posture. Moreover, during tilting of the at least one actuator 210, the at least one actuator 210 may be raised or lowered in a manner to provide comfort to the at least one user in performing the relaxing and leisure activities. Further, the determination of the flawed posture and the actuation of the actuator 210 is explained in greater details in conjunction with FIGS. 6-8.

Referring now to FIG. 6, a block diagram 600 of a bed adapting system 602 is illustrated, in accordance with some embodiments of the present disclosure. The bed adapting system 602 may be capable of enhancing sleep quality of the user by providing support to the user and correct the posture when the user may attain the flawed posture. Moreover, the flawed posture may be changed to the corrected posture such that the prolonged effects of the flawed posture may be eliminated.

The bed adapting system 602 may include the sensor unit 306, the control circuit 308, the at least one actuator 210, the at least one adaptive portion 108 and a power supply 604 coupled to the control circuit 308 and the at least one actuator 210. By way of example, the power supply 604 may be a 12v low voltage battery capable of powering the bed adapting system 602. The bed adapting system 602 may be capable of posture management of the at least one user by adapting, via the control circuit 308, to the flawed posture of the user.

The sensor unit 306 may be disposed underneath the at least one adaptive portion 108 i.e., the bottom portion 208. The sensor unit 306 may include a plurality of sensors, which may include, but not limited to pressure sensors, temperature sensors, angle sensors, position sensors, piezo sensors, and the like. Further, the sensor unit 306 may be configured to sense the one or more attributes of the user. By way of example, the one or more attributes may include but not limited to real-time activities of the user, a real-time posture of the user, changes in real-time posture of the user based on ambient conditions, physical characteristics of the user, and biometric characteristics of the user.

To elaborate further, when the at least one user may contact the at least one adaptive portion 108, the sensor unit 306 may be configured to sense the one or more attributes of the user. For example, the load sensor may be configured to measure the weight distribution of the user on the at least one adaptive portion 108, the piezoelectric sensor may detect the changes in pressure applied by the at least one user on the at least one adaptive portion, the ultrasound sensors may monitor the real-time position of the at least one user on the at least one adaptive portion 108, the temperature sensors may changes in real-time posture of the at least one user, and the Inertial Measurement Unit (IMU) to measure tilt or inclination. Therefore, the sensor unit 306 may generate sensor data using the plurality of sensors based on the one or more attributes, and may be configured to transmit the sensor data to the control circuit 308 for further processing.

In an embodiment, the one or more attributes of the user may also include historical and real-time activities, a real-time posture, changes in real-time posture of the user due to ambient conditions, physical characteristics, and biometric characteristics of the user. These one or more attributes of the user may be stored in a memory (explained later) of the control circuit 308. The control circuit 308 may be coupled to the actuator 210 and may be implemented using a processor 606. The processor 606 may include a controller 608 and a memory 610 communicably coupled to the controller 608. By way of example, the control circuit 308 may be a flat board configured to physically support and electrically connect electronic components using conductive pathways, which may be made of copper. The control circuit 308 plays a crucial role in ensuring electrical signals are properly routed between the controller 608 and the memory 610.

In an embodiment, examples of processor(s) 606 may include, but are not limited to, an Intel® Itanium® or Itanium 2 processor(s), or AMD® Opteron® or Athlon MP® processor(s), Motorola® lines of processors, Nvidia®, FortiSOC™, system on a chip processors or other future processors.

The controller 608 may be electrically connected to the sensor unit 306, via the communication link 404. In an embodiment, the communication between various components of the bed adapting system 602 may be based on a wired or a wireless network connection or a combination thereof. For example, the at least one actuator 210 may be interconnected and coupled to the controller 608. In an embodiment, the communication link 404 may be a wired or a wireless network or a combination thereof. The communication link 404 can be implemented as one of the different types of networks, such as but not limited to, ethernet IP network, intranet, local area network (LAN), wide area network (WAN), or a Metropolitan Area Network (MAN). Various devices in the bed adapting system 602 may be configured to connect to the communication link 404, in accordance with various wired and wireless communication protocols. Examples of such wired and wireless communication protocols may include, but are not limited to, a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols. Further the communication link 404 can include a variety of network devices, including routers, bridges, servers, computing devices, storage devices, and the like.

The memory 610 may store processor-executable instructions that, when executed by the controller 608 of the processor 606, may cause the controller 608 to adapt at least one adaptive portion 108 based on the flawed posture of the at least one user. The memory 610 may include a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.). The memory 610 may also store various data received from the sensor unit 306 (for example, the one or more attributes explained earlier), predefined data on flawed portions, that may be captured, processed, and/or required by the bed adapting system 602 to actuate the telescopic arm 302 of the actuator 210 coupled to the corresponding adaptive potion 108. The actuation of the actuator 210 by the controller 608 is explained in greater details, hereinafter.

The controller 608 may receive sensor data from the sensor unit 306 when the at least one user may be in contact with the at least one adaptive portion 108 within the surface grid 106 of the bed 102. Moreover, the one or more attributes of the at least one user may be sensed by the sensor unit (not shown) based on the plurality of contact points in contact with the at least one adaptive portion 108. Accordingly, the sensor data may be generated and transmitted to the controller 608 for further processing. The controller 608 may process the one or more attributes such that, the flawed posture corresponding to the user may be determined.

In an embodiment, the controller 608 may be configured to process the one or more attributes corresponding to the user using a machine learning model for determining the flawed posture. The machine learning model may be a part of a computer vision software developed by training one or more neural networks based on the one or more attributes determined by the sensor unit 306, and stored in the memory 610.

In an embodiment, the machine learning model generation involves receiving or collecting training data in form of predetermined datasets to train at least one neural network. The predetermined datasets may include but not limited to the sensor data i.e., the one or more attributes determined by the sensor unit 306 in conjunction with the controller 608, correct posture data, historical and real-time activities, changes in real-time posture of the user due to ambient conditions, physical characteristics, and biometric characteristics of the user.

In an embodiment, physical characteristics may include but not limited to body size, weight distribution, height, muscle tone, joint flexibility, and skeletal structure, and the like.

In an embodiment, the correct posture data may be obtained from a correct posture dataset, which may be a collection of data and guidelines that focus on maintaining proper body alignment during activity, rest and sleep. The correct posture dataset may include recommended sleeping positions, mattress firmness, pillow placement, and body support to promote spinal alignment, reduce pressure points, and prevent musculoskeletal discomfort. The correct posture dataset provides data on the ideal alignment of the head, neck, spine, and limbs while lying in various positions, such as on the back, side, or stomach.

The correct posture dataset may also include recommendations for adjusting the one or more adaptive portions 108, such as choosing the appropriate distance, or inclination to actuate the actuator by a predefined distance to align the body of the user at the correct posture. Additionally, the correct posture dataset may offer insights into the optimal duration of sleep for maintaining posture and preventing pain, along with the effects of improper sleeping posture on long-term health.

In an embodiment, the historical and real-time activities may include previous activities of the at least one user on the adaptive portion 108. Further, the biometric characteristics may include body measurements, heart rate, respiratory rate, body temperature, and muscle activity. For example, heart rate and respiratory rate may provide insights into the person's comfort level, as irregular or elevated rates could indicate discomfort or poor alignment during sleep. Body temperature can influence posture as well, with individuals adjusting their position to maintain comfort in response to changes in ambient temperature or personal warmth.

In an embodiment, changes in real-time posture of the user due to ambient conditions may external environmental factors that influence an individual's body alignment and positioning. These factors may include temperature, humidity, lighting, noise levels, and the conditions of seating or the condition of the at least one adaptive portion. For example, in cold environments i.e., when an air conditioner temperature may reduce below a tolerance limit of the user especially in the night, the individual may adopt a hunched or slouched posture to preserve body heat, while in hot conditions especially when the temperature of the room increase above the tolerance limit, the individual may stretch out or slump to increase comfort. Further, in the low lighting i.e., when the user may be watching TV or mobile phone, the individual may be required to lean forward or strain their neck to improve visibility, whereas in the bright lighting i.e., when the sunlight may be entering directly into the room, the individual may result in tilting of the head or adopting a forward head posture to avoid glare.

The controller 608, by using the machine learning model with one or more attributes, may determine a flawed posture of the user. The flawed portion may be determined based on the sensor data corresponding to the one or more attributes of the at least one user. The controller 608 may be configured to analyze a deviation of the one or more attributes corresponding to a posture of the at least one user with the one or more attributes corresponding to a correct posture. In case the deviation may exceed a predefined threshold, a flawed configuration may be determined by the controller 608.

In an exemplary embodiment, ambient conditions, such as room temperature, lighting, and noise levels, can further exacerbate posture problems. Extreme temperatures may prompt individuals to adopt uncomfortable positions, while poor lighting may lead to subconscious slouching. Biometric characteristics, including age, weight distribution, and any pre-existing injuries or chronic pain, also play a significant role in determining posture on a bed, as these factors may compel an individual to assume non-ergonomic positions for comfort. The body position itself—whether supine, prone, or lateral—can affect spinal alignment, with each position potentially leading to pressure on different parts of the body if not supported correctly.

Hence, the controller 608 may be configured to determine one or more attributes corresponding to a real-time posture, such as physical characteristics, ambient conditions, biometric characteristics, position, weight distribution, etc., and may determine a deviation with the same attributes corresponding to the corrected posture. In case the deviation exceeds a predefined threshold, the real-time posture may be identified as the flawed posture. To elaborate the physical characteristics of the user, consider the scenario that the user may be obese. In such scenario, an excess amount of fat near the neck may be blocking nostrils of the user, as a result the snoring may occur during sleep. This may be identified as the flawed posture by the controller 608. Therefore, the user is required to move to the left side in order to increase air passage, thus decrease the snoring. This may be identified as the correct posture by the controller 608.

The controller 608 may determine a corrected posture from the correct posture dataset, or predict with machine learning a futuristic posture which may be equivalent to the corrected posture. Consequently, the controller 608 may generate an actuation signal which may include one or more attributes associated with the correct posture corresponding to the flawed posture to the at least one actuator 210. Based on the actuation signal, the controller 608 may be configured to adapt the at least one actuator 210 based on the actuation signal for adapting, or implementing micro-adjustments to the at least one adaptive portion 108 corresponding to the flawed posture. The adapting, or implementing micro-adjustments of the at least one actuator 210 may be continued until the deviation of the one or more attributes falls below a predefined threshold, or the posture of the user changes to the corrected posture. The adapting of the at least one actuator 210 is explained in greater details, hereinafter.

In response to the actuation signal, the lifting column 303 may be activated to actuate the telescopic arm 302. Upon activation, the lifting column 303 may exert the linear force on the telescopic arm 302. By virtue of linear force, the plurality of arms may be micro-adjusted, or may be raised or lowered by a predefined distance. The raising and lowering may result in manipulation of the at least one adaptive portion 108 corresponding to the flawed posture by the predefined distance. Moreover, when the predefined distance may be attained, the controller 608 may actuate the magnetic pin connector 304 such that a pin of the magnetic pin connector 304 may be engaged to the slot of the telescopic arm 302. Thus, the motion of the telescopic arm 302 may be restricted in the predefined distance. Therefore, the adaptive portions 108 corresponding to the flawed posture may be adapted to implement correct posture of the user.

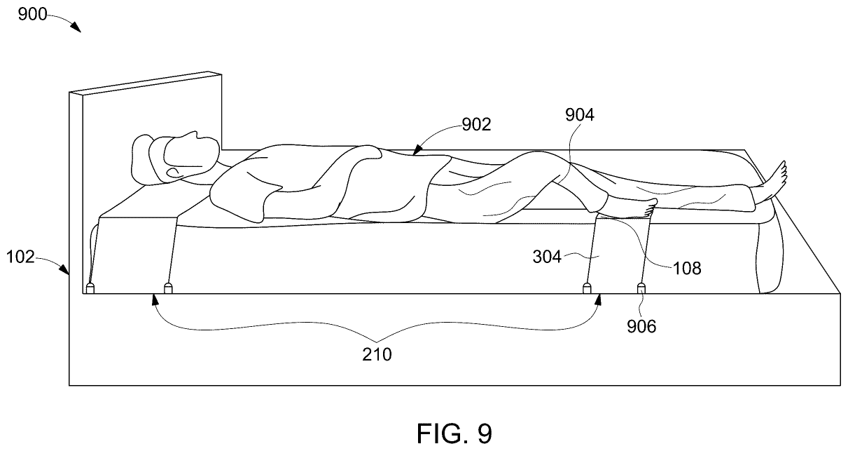

Moreover, the telescopic arm 302 may be tilted by the predefined angle around a pivot joint (not shown in FIG. 6) disposed to the base 202. The pivot joint may be electrically-operated to allow the tilting of the telescopic arm 302 by the predefined angle. As a result, each telescopic arm of the corresponding actuator 210 may be dynamically raised or lowered and tilted to correct the flawed posture of the at least one user. This is explained in greater details in conjunction with FIG. 9.

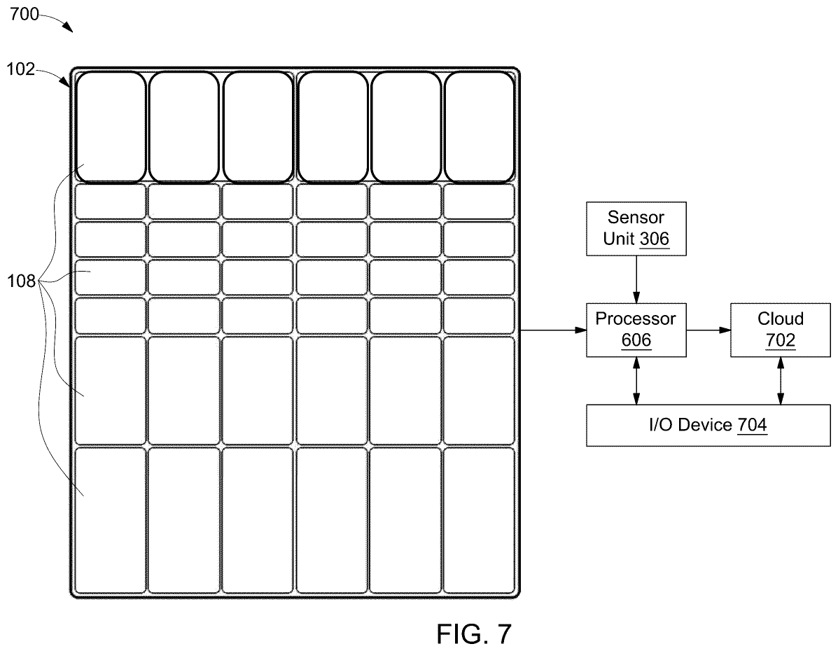

Referring now to FIG. 7, another block diagram 700 of the bed adapting system 602 is illustrated, in accordance with some embodiments of the present disclosure. FIG. 7 is explained in conjunction with FIG. 6. As explained earlier, the at least one adaptive portion 108, the at least one actuator 210 operatively coupled to the processor 606, the sensor unit 306 communicably coupled to the processor 606, a cloud 702 communicably connected to the processor 606, and an input/output (I/O) device 704 communicably connected to the processor 606 and the cloud 702.

In an embodiment, the I/O device 704 may be communicably connected to the processor 606. Further, the I/O device 704 may be configured to provide an input or set of manual instructions for manual adjustment of the at least one adaptive portion 108 in order to achieve corrected posture. The I/O device may include a variety of interface(s), for example, interfaces for data input and output devices, and the like. The I/O device 704 may facilitate the submission of instructions by the at least one user communicating with the processor 606. In an embodiment, the I/O device 704 may be wirelessly connected to the processor 606 through wireless network interfaces such as Bluetooth®, infrared, or any other wireless radio communication known in the art. In an embodiment, the I/O device 704 may be connected to a communication pathway for one or more components of the processor 606 to facilitate the transmission of inputted instructions and output results of data generated by various components such as, but not limited to, controller(s) 608 and memory 610.

Further, the controller 608 may receive the input from the I/O device 704 to actuate the at least one actuator 210. Each actuator 210 may manipulate the telescopic arm 302 to raise or lower the at least one adaptive portion 108 corresponding to the flawed posture by the predefined distance. Such manipulation may be based on processing of one or more attributes by the processor 606. The one or more attributes may be processed to generate the information associated with the corrected posture corresponding to the flawed posture. Such information may be stored or shared such as the datasets from the one or more sensor data as well as state and decision points that may be shared with remote servers to further improve the machine learning model or for other purposes such as regulatory or training purposes. This information may be stored locally on a remote storage such as a server or on the cloud 702. The actuation of the at least one actuator 210 is already explained in FIGS. 1-6.

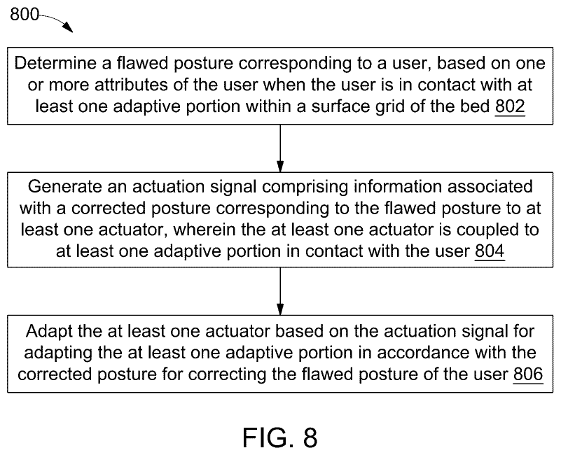

Referring now to FIG. 8, a methodology 800 of adapting the bed 102 is illustrated, in accordance with some embodiments of the present disclosure. At step 802, the controller 608 may determine the flawed posture corresponding to a user, based on one or more attributes of the at least one user when the at least one user may be in contact with the at least one adaptive portion 108 within the surface grid 106 of the bed 102. In other words, the controller 608 based on the sensor data received by the sensor unit 306, may determine the flawed posture of corresponding to the at least one user. At step 804, the controller 608, upon determining the flawed posture, may generate the actuation signal which may include information associated with a corrected posture corresponding to the flawed posture to the at least one actuator 210 coupled to the at least one adaptive portion 108. At step 806, the controller 608, based on the actuation signal, may adapt the at least one actuator 210 for adapting the at least one adaptive portion 108 in accordance with the corrected posture for correcting the flawed posture of the user. In accordance with the corrected posture, the at least one actuator 210 may be actuated by the predefined distance, for adjusting the flawed posture of the at least one user to the corrected posture.

FIG. 9 illustrates a first-side view of the bed 102 with the at least one adaptive portion 108, in accordance with some embodiments of the present disclosure. FIG. 9 depicts a user 902 sleeping on the at least one adaptive portion 108 with the flawed posture. Further, the flawed posture may be determined by the controller 608 with the one or more attributes, such as a position of a leg 904. Using the methodology as explained in FIGS. 1-8, the controller 608 may actuate the at least one actuator 210 corresponding to the flawed posture. As apparent from the FIG. 9, a leg 904 from the pair of legs 904 of the user 902 may depict the flawed posture. Further, the telescopic arm 302 of the actuator 210 may be actuated by the predefined distance in the vertically upward direction and may be tilted by the predefined angle ranging about 5°-about 10° around a pivot joint 906 in such a manner that, the flawed posture may be corrected.

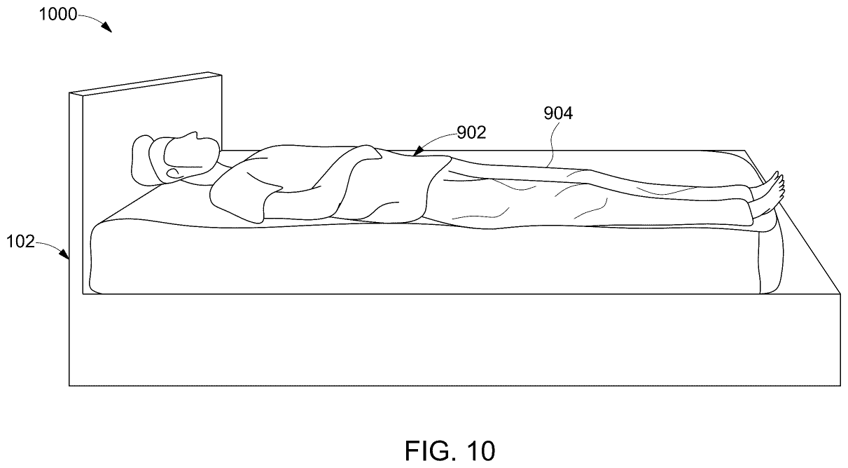

FIG. 10 illustrates a second-side view 1000 of the bed 102 in the corrected posture, in accordance with some embodiments of the present disclosure. FIG. 10 is explained in conjunction with FIG. 9. FIG. 10 depicts the user 902 sleeping on the at least one adaptive portion 108 with the correct posture. The correct posture may be achieved by the bed adapting system 602 by allowing the vertical movement i.e., raising and lowering of the at least one adaptive portion 108 and the tilting motion. As apparent from FIG. 10, upon correcting the posture of the user 902, controller 608 may deactivate the actuator 210 i.e., the telescopic arm 302 may be lowered such that the user 902 may be capable of performing leisure activities comfortably. The bed adapting system 602 is already explained in greater detail in conjunction with FIG. 6-9.

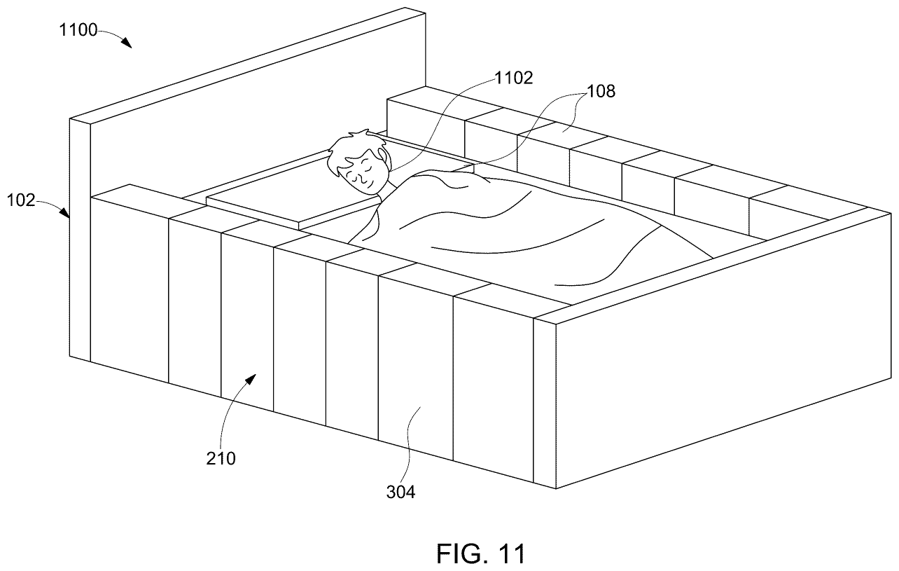

FIG. 11 illustrates a perspective view 1100 of the bed 102 in a safety configuration, in accordance with some embodiments of the present disclosure. FIG. 11 depicts the bed 102 in the safety configuration. The safety configuration may include actuation of the at least one adaptive portion 108 on the perimeter 107 of the surface grid 106 when at least one user 1102 may be sleeping. Herein, any flawed posture may result in the at least one user 1102 rolling subconsciously and falling off the bed 102.

As explained earlier, the controller 608 may be communicably coupled to the sensor unit 306. Further, the sensor unit 306 may be configured to monitor the undesired movement of the at least one user 1102 sleeping on the at least one adaptive portion 108. By way of example, the undesired movement may be a subconscious rolling motion of the user 902. Therefore, the user 1102 may fall off on a ground surface. Further, the controller 608 may be configured to determine the user 1102 falling off from at least one adaptive portion 108 within the surface grid 106 due to the flawed posture based on the sensor data received from the sensor unit 306. Upon determining the user falling, the controller 608 may adapt the at least one adaptive portion 108 on the perimeter 107 of the surface grid 106 to prevent the user 1102 from falling off from at least one adaptive portion 108. Accordingly, the telescopic arm 302 of the corresponding actuator 210 may be actuated by the predefined distance, creating a layer of restriction to prevent the falling of the user 1102 from the at least one adaptive portion 108 onto the ground surface.

In an exemplary embodiment, the prevention of the user 1102 falling off on the ground surface may be enabled based on the input command relayed by at least one user 1102 on the I/O device 704. As explained earlier, the I/O device 704 may be communicably coupled to the processor 606. Based on the input command, the controller 608 may be configured to actuate the at least one adaptive portion 108 on the perimeter 107 of the surface grid 106. This is already explained in conjunction with FIG. 9-10.

As will be also appreciated, the above-described techniques may take the form of computer or controller-implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

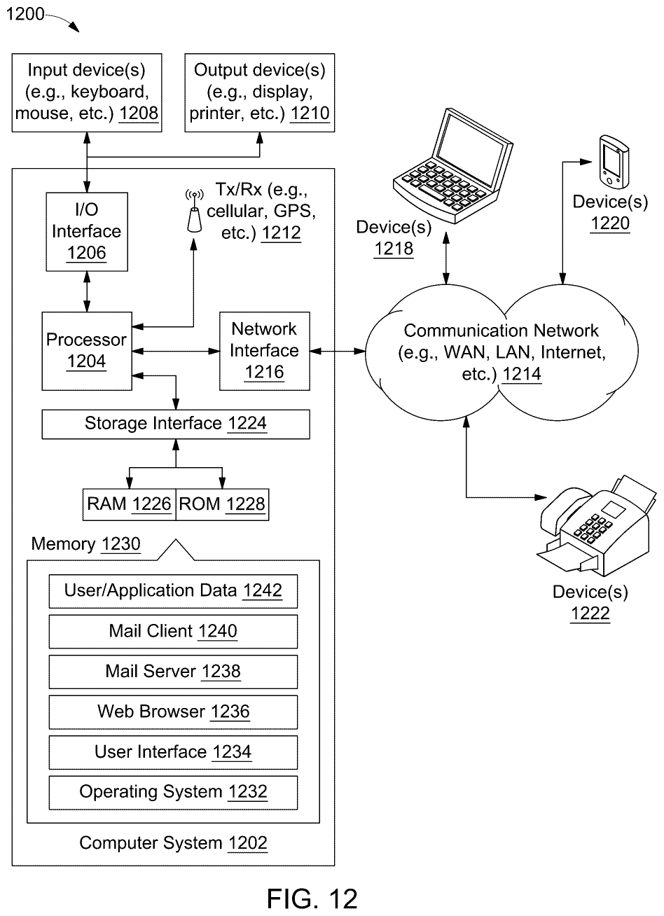

The disclosed methods and systems may be implemented on a conventional or a general-purpose computer system, such as a personal computer (PC) or server computer equipped with an application data server. Referring now to FIG. 12, a block diagram 1200 of an exemplary computer system 1202, similar to the processor 606, for correcting flawed posture of the at least one user is illustrated. The computer system 1202 may include a central processing unit (“CPU” or “processor”) 1204. The processor 1204 may include at least one data processor for executing program components for executing user-generated or system-generated requests. A user may include a person, a person using a device such as such as those included in this disclosure, or such a device itself. The processor 1204 may include specialized processing units such as integrated system (bus) controllers, memory management control units, floating point units, graphics processing units, digital signal processing units, etc. The processor 1204 may include a microprocessor, such as AMD® ATHLON®, DURON® OR OPTERON®, ARM's application, embedded or secure processors, IBM® POWERPC®, INTEL® CORE® processor, ITANIUM® processor, XEON® processor, CELERON® processor or other line of processors, etc. The processor 1204 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 1204 may be disposed in communication with one or more input/output (I/O) devices via I/O interface 1206. The I/O interface 1206 may employ communication protocols/methods such as, without limitation, audio, analog, digital, monoaural, RCA, stereo, IEEE-1394, near field communication (NFC), FireWire, Camera Link®, GigE, serial bus, universal serial bus (USB), infrared, PS/2, BNC, coaxial, component, composite, digital visual interface (DVI), high-definition multimedia interface (HDMI), radio frequency (RF) antennas, S-Video, video graphics array (VGA), IEEE 802.n/b/g/n/x, Bluetooth, cellular (e.g., code-division multiple access (CDMA), high-speed packet access (HSPA+), global system for mobile communications (GSM), long-term evolution (LTE), WiMAX, or the like), etc.

Using the I/O interface 1206, the computer system 1202 may communicate with one or more I/O devices. For example, the input device 1208 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, altimeter, gyroscope, proximity sensor, or the like), stylus, scanner, storage device, transceiver, video device/source, visors, etc. Output device 1210 may be a printer, fax machine, video display (e.g., cathode ray tube (CRT), liquid crystal display (LCD), light-emitting diode (LED), plasma, or the like), audio speaker, etc. In some embodiments, a transceiver 1212 may be disposed in connection with the processor 1204. The transceiver may facilitate various types of wireless transmission or reception. For example, the transceiver may include an antenna operatively connected to a transceiver chip (e.g., TEXAS INSTRUMENTS® WILINK WL1286®, BROADCOM® BCM4550IUB8®, INFINEON TECHNOLOGIES® X-GOLD 1236-PMB9800® transceiver, or the like), providing IEEE 802.11a/b/g/n, Bluetooth, FM, global positioning system (GPS), 2G/3G HSDPA/HSUPA communications, etc.

In some embodiments, the processor 1204 may be disposed in communication with a communication network 1216 via a network interface 1214. The network interface 1214 may communicate with the communication network 1216. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 1216 may include, without limitation, a direct interconnection, local area network (LAN), wide area network (WAN), wireless network (e.g., using Wireless Application Protocol), the Internet, etc. Using the network interface 1214 and the communication network 1216, the computer system 1202 may communicate with devices 1218, 1220, and 1222. These devices may include, without limitation, personal computer(s), server(s), fax machines, printers, scanners, various mobile devices such as cellular telephones, smartphones (e.g., APPLE® IPHONE®, BLACKBERRY® smartphone, ANDROID® based phones, etc.), tablet computers, eBook readers (AMAZON® KINDLE®, NOOK® etc.), laptop computers, notebooks, gaming consoles (MICROSOFT® XBOX®, NINTENDO® DS®, SONY® PLAYSTATION®, etc.), or the like. In some embodiments, the computer system 1202 may itself embody one or more of these devices.

In some embodiments, the processor 1204 may be disposed in communication with one or more memory devices 1230 (e.g., RAM 1226, ROM 1228, etc.) via a storage interface 1224. The storage interface may connect to memory devices 1230 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), STD Bus, RS-232, RS-422, RS-485, I2C, SPI, Microwire, 1-Wire, IEEE 1284, Intel® QuickPathInterconnect, InfiniBand, PCIe, etc. The memory drives may further include a drum, magnetic disc drive, magneto-optical drive, optical drive, redundant array of independent discs (RAID), solid-state memory devices, solid-state drives, etc.

The memory devices 1230 may store a collection of program or database components, including, without limitation, an operating system 1232, user interface application 1234, web browser 1236, mail server 1238, mail client 1240, user/application data 1242 (e.g., any data variables or data records discussed in this disclosure), etc. The operating system 1232 may facilitate resource management and operation of the computer system 1202. Examples of operating systems include, without limitation, APPLE® MACINTOSH® OS X, UNIX, Unix-like system distributions (e.g., Berkeley Software Distribution (BSD), FreeBSD, NetBSD, OpenBSD, etc.), Linux distributions (e.g., RED HAT®, UBUNTU®, KUBUNTU®, etc.), IBM® OS/2, MICROSOFT® WINDOWS® (XP®, Vista®/7/8, etc.), APPLE® IOS®, GOOGLE® ANDROID®, BLACKBERRY® OS, or the like. User interface 1234 may facilitate display, execution, interaction, manipulation, or operation of program components through textual or graphical facilities. For example, user interfaces may provide computer interaction interface elements on a display system operatively connected to the computer system 1202, such as cursors, icons, check boxes, menus, scrollers, windows, widgets, etc. Graphical user interfaces (GUIs) may be employed, including, without limitation, APPLE® MACINTOSH® operating systems' AQUA® platform, IBM® OS/2®, MICROSOFT® WINDOWS® (e.g., AERO®, METRO®, etc.), UNIX X-WINDOWS, web interface libraries (e.g., ACTIVEX®, JAVA®, JAVASCRIPT®, AJAX®, HTML, ADOBE® FLASH®, etc.), or the like.

In some embodiments, the computer system 1202 may implement a web browser 1236 stored program component. The web browser may be a hypertext viewing application, such as MICROSOFT® INTERNET EXPLORER®, GOOGLE® CHROME®, MOZILLA® FIREFOX®, APPLE® SAFARI®, etc. Secure web browsing may be provided using HTTPS (secure hypertext transport protocol), secure sockets layer (SSL), Transport Layer Security (TLS), etc. Web browsers may utilize facilities such as AJAX®, DHTML, ADOBE® FLASH®, JAVASCRIPT®, JAVA®, application programming interfaces (APIs), etc. In some embodiments, the computer system 1202 may implement a mail server 1238 stored program component. The mail server may be an Internet mail server such as MICROSOFT® EXCHANGE®, or the like. The mail server may utilize facilities such as ASP, ActiveX, ANSI C++/C#, MICROSOFT. NET® CGI scripts, JAVA®, JAVASCRIPT®, PERL®, PHP®, PYTHON®, WebObjects, etc. The mail server may utilize communication protocols such as internet message access protocol (IMAP), messaging application programming interface (MAPI), MICROSOFT® EXCHANGE®, post office protocol (POP), simple mail transfer protocol (SMTP), or the like. In some embodiments, the computer system 1202 may implement a mail client 1240 stored program component. The mail client may be a mail viewing application, such as APPLE MAIL®, MICROSOFT ENTOURAGE®, MICROSOFT OUTLOOK®, MOZILLA THUNDERBIRD®, etc.

In some embodiments, the memory 1230 may store user/application data 1242, such as the data, variables, records, etc. (e.g., the set of predictive models, the plurality of clusters, set of parameters (batch size, number of epochs, learning rate, momentum, etc.), accuracy scores, competitiveness scores, ranks, associated categories, rewards, threshold scores, threshold time, and so forth) as described in this disclosure. Such databases may be implemented as fault-tolerant, relational, scalable, secure databases such as ORACLE® OR SYBASE®. Alternatively, such databases may be implemented using standardized data structures, such as an array, hash, linked list, struct, structured text file (e.g., XML), table, or as object-oriented databases (e.g., using OBJECTSTORE®, POET®, ZOPE®, etc.). Such databases may be consolidated or distributed, sometimes among the various computer systems discussed above in this disclosure. It is to be understood that the structure and operation of the any computer or database component may be combined, consolidated, or distributed in any working combination.

For example, the memory 1230 may store process-executable instructions, which when executed by the processor 1204, may cause the processor 1204 to determine a flawed posture corresponding to a user, based on one or more attributes of the user when the user is in contact with the at least one adaptive portion 108 within a surface grid 106 of the bed 102. The processor 1204 may be configured to generate an actuation signal comprising information associated with a corrected posture corresponding to the flawed posture to at least one actuator 210. Further, the processor 1204 may be configured to adapt the at least one actuator 210 based on the actuation signal for adapting the at least one adaptive portion 108 in accordance with the corrected posture for correcting the flawed posture of the user. Therefore, the flawed posture of the at least one user may be corrected.

Thus, the present disclosure may overcome drawbacks of conventional beds that are designed without focusing on sleeper's position and pressure distribution. The present disclosure discloses a bed with adaptive portions catering to problems associated with the existing conventional beds. The bed may be capable of determining the optimal configuration for the at least one adaptive portion, ensuring proper spine alignment and pressure relief. Upon determining the optimal configuration for the at least one adaptive portion, the bed operates on a bed adapting system capable of dynamically adapting the at least one actuator in accordance with the corrected posture for correcting the flawed posture of the user.

The disclosed system may provide a mobile app-user interaction (such as any software application). The system allows the user to interact with the bed, customise settings, and select from various preset modes tailored to different sleep postures and conditions via the I/O device i.e., the mobile app, smartphone, and the like. Therefore, the system may be capable of allowing the at least one user to manually adjust the bed settings via the mobile app. Various modes are available for specific use cases, such as reading, watching TV, intimacy, or different sleep postures.

Further, the system enables connection to the local network, enabling interaction with other I/O devices. This connectivity allows for seamless integration into smart home systems, providing users with a cohesive and automated sleep environment. Further, the system enables adjustment of flawed posture of the user and accu-pressure needs throughout the night. Additionally, the disclosed smart bed may automatically adopt different positions for the user as per their needs. The at least one adaptive portion of the bed along with the at least one actuator may be reclined using dedicated telescopic arms, to provide superior head rest, back rest, and leg rest.

Considering the above-mentioned advantages and the technical advancements provided by the disclosed portable smoking chamber, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with embodiments, one skilled in the art would recognize that various features of the described embodiments may be combined in accordance with the invention.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

I/We claim:

1. A method, comprising:
receiving, by a controller, sensor data associated with a user, based on the user being in contact with at least one adaptive portion within a surface grid of a bed, wherein the sensor data is generated by at least one sensor in the at least one adaptive portion;
determining, by the controller, one or more attributes of the user based on the sensor data;
determining, by the controller, a flawed posture corresponding to the user based on the one or more attributes of the user, wherein
the flawed posture corresponds to a deviation of the one or more attributes of the user from a correct posture, and
the correct posture is based on dataset of specific body alignment;
generating, by the controller, an actuation signal comprising information associated with the correct posture corresponding to the flawed posture, for at least one actuator, wherein the at least one actuator is coupled to the at least one adaptive portion in contact with the user;
controlling, by the controller, the at least one actuator based on the actuation signal; and
adjusting, by the controller, the at least one adaptive portion based on the controlling of the actuator and the correct posture, for correcting the flawed posture of the user.

2. The method of claim 1, wherein the controlling of the at least one actuator comprises:
actuating, in real time, the actuator to move, based on the correct posture, for adjusting the flawed posture of the user to the correct posture.

3. The method of claim 1, wherein
the sensor data is from a sensor unit,
the sensor unit is underneath the at least one adaptive portion in contact with the user, and
the determining of the flawed posture further comprises:
processing, by the controller using a machine learning model, the one or more attributes corresponding to the user for the determining of the flawed posture.

4. The method of claim 3, wherein the one or more attributes of the user comprises at least one of:
historical and real-time activities of the user,
a real-time posture of the user,
changes in real-time posture of the user based on ambient conditions,
physical characteristics of the user, and
biometric characteristics of the user.

5. The method of claim 1, further comprising:
determining, by the controller, using a machine learning model with the one or more attributes of the user:
the correct posture corresponding to the flawed posture; and
a predicted posture corresponding to the user, wherein the machine learning model is a neural network trained with historical sensor datasets and correct posture datasets.

6. The method of claim 1, wherein each actuator of the at least one actuator comprises:
a telescopic arm that is positioned at a base of a main frame, wherein the telescopic arm is coupled to a bottom of the at least one adaptive portion;
based on the actuation signal, the actuator is configured to move the telescopic arm to one of raise or lower the at least one adaptive portion corresponding to the flawed posture.

7. The method of claim 1 and further comprising:
determining, by the controller, the user falling off from the at least one adaptive portion due to the flawed posture, based on the sensor data; and
controlling, by the controller, the at least one adaptive portion on a perimeter of the surface grid for preventing the user from falling off from the at least one adaptive portion.

8. A bed, comprising:
a surface grid comprising:
at least one adaptive portion;
at least one actuator coupled to the at least one adaptive portion;
a controller; and
a memory communicably coupled to the controller, wherein the memory comprises a set of instructions which when executed by the controller, causes the controller to:
receive sensor data associated with a user, based on the user being in contact with the at least one adaptive portion within the surface grid of the bed, wherein the sensor data is generated by at least one sensor in the at least one adaptive portion;
determine one or more attributes of the user based on the sensor data;
determine a flawed posture corresponding to the user, based on the one or more attributes of the user, wherein
the flawed posture corresponds to a deviation of the one or more attributes of the user from a correct posture, and
the correct posture is based on dataset of specific body alignment;
generate an actuation signal comprising information associated with the correct posture corresponding to the flawed posture, for the at least one actuator, wherein the at least one actuator is coupled to the at least one adaptive portion in contact with the user;
control the at least one actuator based on the actuation signal; and
adjust the at least one adaptive portion based on the controlling of the actuator and the correct posture, for correcting the flawed posture of the user.

9. The bed of claim 8, wherein the control of the at least one actuator comprises:
actuation, in real time, of the actuator to move, based on the correct posture, to adjust the flawed posture of the user to the correct posture.

10. The bed of claim 8, wherein
the sensor data is from a sensor unit,
the sensor unit is underneath the at least one adaptive portion in contact with the user, and
the determination of the flawed posture, the set of instructions causes the controller to:
process using a machine learning model, the one or more attributes corresponding to the user for the determination of the flawed posture.

11. The bed of claim 8, wherein the one or more attributes of the user comprises at least one of:
historical and real-time activities of the user,
a real-time posture of the user,
changes in real-time posture of the user based on ambient conditions,
physical characteristics of the user, and
biometric characteristics of the user.

12. The bed of claim 8, wherein to determine the corrected posture, the set of instructions further causes the controller to:
determine using a machine learning model with the one or more attributes of the user:
the correct posture corresponding to the flawed posture; and
a predicted posture corresponding to the user, wherein the machine learning model is a neural network trained with historical sensor datasets and correct posture datasets.

13. The bed of claim 8, wherein each actuator of the at least one actuator comprises:
a telescopic arm positioned at a base of a main frame, wherein the telescopic arm is coupled to a bottom of the at least one adaptive portion,
based on the actuation signal, the actuator is configured to move the telescopic arm, to one of raise or lower the at least one adaptive portion corresponding to the flawed posture.

14. The bed of claim 13, wherein the telescopic arm is coupled to a lifting column, wherein the lifting column is accommodated between the bottom of the at least one adaptive portion and the telescopic arm.

15. The bed as claimed in claim 8, wherein the set of instructions further causes the controller to:
determine the user falling off from the at least one adaptive portion within the surface grid due to the flawed posture, based on the sensor data; and
control the at least one adaptive portion on a perimeter of the surface grid to prevent the user from falling off from the at least one adaptive portion.

16. An application server, comprising:
a controller; and
a memory communicably coupled to the controller, wherein the memory comprises a set of instructions which when executed by the controller, causes the controller to:
receive sensor data associated with a user, based on the user being in contact with at least one adaptive portion within a surface grid of a bed, wherein the sensor data is generated by at least one sensor in the at least one adaptive portion;
determine one or more attributes of the user based on the sensor data;
determine a flawed posture corresponding to the user, based on the one or more attributes of the user wherein
the flawed posture corresponds to a deviation of the one or more attributes of the user from a correct posture, and
the correct posture is based on dataset of specific body alignment;
generate an actuation signal comprising information associated with the correct posture corresponding to the flawed posture, for at least one actuator, wherein the at least one actuator is coupled to the at least one adaptive portion in contact with the user;
control the at least one actuator based on the actuation signal; and
adjust the at least one adaptive portion based on the controlling of the actuator and the correct posture, for correcting the flawed posture of the user.

17. The application server of claim 16, wherein
the sensor data is from a sensor unit,
the sensor unit is underneath the at least one adaptive portion in contact with the user, and
for the determination of the flawed posture, the set of instructions causes the controller to:
process, using a machine learning model, the one or more attributes corresponding to the user for the determination of the flawed posture.

18. The application server of claim 16, wherein the one or more attributes of the user comprises at least one of:
historical and real-time activities of the user;
a real-time posture of the user;
changes in real-time posture of the user based on ambient conditions;
physical characteristics of the user; and
biometric characteristics of the user.

19. The application server of claim 18, wherein for the determination of the correct posture, the set of instructions further causes the controller to:
determine using a machine learning model with the one or more attributes of the user:
the correct posture corresponding to the flawed posture; and
a predicted posture corresponding to the user, wherein the machine learning model is a neural network trained with historical sensor datasets and correct posture datasets.
